(19) United States
(12) Patent Application Publication
(10) Pub. No.: US 2006/0241726 A1
(43) Pub. Date: Oct. 26, 2006

(54) Cosmetic or therapeutic methods and apparatus

(76) Inventor: Colin Whitehurst, Cheshire (GB)

Correspondence Address: STERNE, KESSLER, GOLDSTEIN & FOX PLLC, 1100 NEW YORK AVENUE, N.W., WASHINGTON, DC, 20005, US

(21) Appl. No.: 10/547,137

(22) PCT Filed: Feb. 26, 2004
(86) PCT No.: PCT/GB04/00758

§ 371 Date: Jun. 9, 2006

(30) Foreign Application Priority Data
Feb. 26, 2003 (WO) PCT/GB03/00834

(51) Int. Cl. A61H 33/00

(52) U.S. Cl. 607/86

(57) ABSTRACT

A method of photorejuvenation, wrinkle removal, wound healing and/or pain reduction comprises irradiation with light of a wavelength substantially within the range of 610-680 nm, and preferably having a maximum intensity around 630 nm, or substantially within the range of 800-880 nm, and preferably having a maximum intensity around 830 nm. A method of photorejuvenation comprises irradiation with light of a wavelength substantially within the range 550-600 nm and preferably having a maximum intensity around 585 nm. A method of promoting healing of wounds or tissue damage comprises irradiating the affected area with polychromatic radiation substantially within the wavelength range of 405 to 904 nm. Preferably, the radiation has substantial intensity at a wavelength of one or more of 633, 680 or 780 nm, so as to stimulate DNA/RNA synthesis. Preferably, the radiation has substantial intensity at a wavelength of 750 nm so as to promote protein synthesis/ Preferably, the radiation has substantial intensity at 890 nm, so as to cause increased cell proliferation. Preferably, the radiation has substantial intensity at a wavelength of 880 nm, so as to inhibit fibroblast proliferation. Alternatively, the radiation has substantial intensity at 820 nm and/or 870 nm, so as to enhance the release of stimulating factors. A method of treating hypopigmentary skin disorders, such as vitiligo, comprises irradiating a hypopigmented area of a patient's skin with low intensity ultraviolet radiation. Preferably, the low intensity ultraviolet radiation has substantial intensity at a wavelength of at least one of 365, 400-420 and 434 nm. Preferably, the radiation also has a substantial intensity at a wavelength of approximately 630 nm or 760 nm. The radiation may be provided by an array of discrete light-emitting diodes arranged to emit the light.

### FIELD OF THE INVENTION

The present invention relates to cosmetic or therapeutic methods and apparatus using light with or without a photosensitizer, particularly but not exclusively using light-emitting diodes (LED's).

### BACKGROUND OF THE INVENTION

The document US2003/0004499 discloses the use of LED's for wound healing and wrinkle removal.

EP-A-0 320 080 discloses using LED's for biostimulation.

U.S. Pat. No. 6,602,275 discloses the use of LED's for pain relief and healing.

The documents WO 95/19809 and WO95/19810 disclose devices for healing wounds and sores by means of a light-emitting element which emits pulsed infrared light during a first period and pulsed red light during a second period. According to this document, it is extremely important that the treatment is carried out in the order infrared light followed by visible light. The light-emitting element includes discrete infrared and red light emitting diodes. In an example, the red emission is at 660 mm and the infrared at 950 nm.

It would be desirable to achieve an improved method of treatment, and a device for use in such a method, for enhancing wound repair, tissue repair, and/or for cosmetic dermatological treatment such as photorejuvenation and wrinkle reduction.

It would also be desirable to achieve an improved method of treatment, and a device for use in such a method, for pain control.

It would also be desirable to achieve an improved method of treatment, and a device for use in such a method, for hypopigmentary skin disorders.

Certain hypopigmentary skin disorders, such as vitiligo, are characterised by a loss of melanocytes from the epidermis, which results in the absence of melanin, i.e. depigmentation. The problem of vitiligo would be essentially solved if there were a treatment that is well tolerated in children, adults and pregnant women, and that would halt the progression of the depigmentation.

### STATEMENT OF THE INVENTION

According to a first aspect of the present invention, there is provided a method of photorejuvenation, wrinkle removal and/or wound healing by irradiating the affected area with light of a wavelength substantially within the range of 610-680 nm, and preferably having a maximum intensity around 630 nm.

According to a second aspect of the invention, there is provided a method of photorejuvenation, wrinkle removal, wound healing and/or pain reduction by irradiating the affected area with light of a wavelength substantially within the range of 800-880 nm, and preferably having a maximum intensity around 830 nm.

According to the first or second aspects, the intensity of the radiation may be in the range 0.1-1000 mW/cm², and preferably within the range 1-100 mW/cm². The total light dose may be within the range 0.1-200 J/cm², and preferably within the range 0.5-100 J/cm².

According to a third aspect of the present invention, there is provided a method of photorejuvenation by irradiating the affected area with light of a wavelength substantially within the range 550-600 nm and preferably having a maximum intensity around 585 nm. This increases the absorption of energy by using photons with wavelengths coincident with the strong absorption band of haemoglobin at 575 nm-585 nm. Once the energy has been effectively coupled into the biological matrix, then biostimulation ensues.

According to the first, second or third aspects, the light may be pulsed or continuous.

Each of the above aspects may be used for photorejuvenation of chronologically-aged or photo-aged skin with or without endogenously or exogenously applied photosensitizer.

The first, second or third aspects may be used for removal or reduction of wrinkles.

The second aspect may be used for the reduction or control of pain, for example during photodynamic treatment of psoriasis, for analgesic effect during other clinical applications, or as a result of injury.

The first or second aspects may be used for healing damaged tissue, for treating sports-related injuries, or for treating skin ulcers.

Each of the above aspects may be used for treating animals, particularly humans or non-human mammals.

According to a fourth aspect of the present invention, there is provided a method of promoting healing of wounds or tissue damage by irradiating the affected area with polychromatic radiation substantially within the wavelength range of 405 to 904 nm. Preferably, the radiation has substantial intensity at a wavelength of one or more of 633, 680 or 780 nm, so as to stimulate DNA/RNA synthesis. Preferably, the radiation has substantial intensity at a wavelength of 750 nm so as to promote protein synthesis. Preferably, the radiation has substantial intensity at 890 nm, so as to cause increased cell proliferation. Preferably, the radiation has substantial intensity at a wavelength of 880 nm, so as to inhibit fibroblast proliferation. Alternatively, the radiation has substantial intensity at 820 nm and/or 870 nm, so as to enhance the release of stimulating factors.

According to a fifth aspect of the present invention, there is provided a method of treating hypopigmentary skin disorders, such as vitiligo, by irradiating a hypopigmented area of a patient's skin with low intensity ultraviolet radiation and/or red light. Preferably, the low intensity ultraviolet radiation has substantial intensity at a wavelength of at least one of 365, 400-420 (preferably 404) and 434 nm. Preferably, the red radiation has a substantial intensity at a wavelength of approximately 630 nm or 760 nm.

According to any of the above aspects, there may be provided a light source for carrying out the method, including an array of light-emitting diodes arranged to emit the light.

Preferably, the light source includes a plurality of the arrays, the configuration of the plurality of arrays being preferably adjustable by the user.

The plurality of arrays may be mounted on an adjustable arm.

### BRIEF DESCRIPTION OF THE DRAWINGS

Specific embodiments of the present invention will now be described with reference to the accompanying drawings, in which:

FIG. 1 is schematic side view of a therapeutic light source in embodiments of the invention;

FIG. 2a is a front perspective view of a light-emitting head of the therapeutic light source showing panels each carrying an LED matrix;

FIG. 2b is a top view of the light-emitting head showing the direction of illumination;

FIG. 3 is a front view of one of the LED matrices;

FIG. 4 is a circuit diagram showing the series-parallel configuration of each LED matrix;

FIG. 5 shows an emission spectrum of an LED for use in a fourth embodiment of the invention; and

FIG. 6 shows emission spectra for an LED for use in a fifth embodiment of the invention.

### DESCRIPTION OF THE EMBODIMENTS

In the following description, references in square brackets are identified in the Reference section at the end of the description.

The first law of photobiology, the science of photochemistry and photophysics, states that without absorption there can be no reaction. Therefore, it is important to know what specific targets to aim for in living tissue. For example, for targeting cells called fibroblasts, which synthesize the collagen of which our skin is formed, red light is most effective [Karu], [Smith], [Abergel]. This is most useful in wound healing and in encouraging collagenesis in the photorejuvenation of photoaged skin. For targeting inflammatory process cells, such as leukocytes and mast cells in the first inflammatory stage of wound healing, and macrophage cells in the second proliferative and early third remodelling stages, then near infrared light of around 830 nm is most effective [Karu], [Young].

Each wavelength has a specific target in the living cell, and these targets are known as chromophores, or photoacceptors. A typical cell consists of a nucleus in the middle of the cell, containing the DNA from which the mother cell can construct similar daughter cells in the process known as replication. Around the periphery of the cell is the cellular membrane, which encloses the cell and protects it from the external environment. The fluid within the cell called the cytoplasm, and in this float a number of important subcellular organelles, such as ribosomes (RNA factories), lysosomes (enzyme factories) and most importantly, mitochondria (power houses of the cells, and manufacturers and regulators of adenine triphosphate (ATP), the fuel of the cell).

In the following embodiments, light of a specified wavelength and intensity is used to target specific parts of the cell to achieve advantageous effects.

Treatment with Visible Red Light

In the first embodiment, the affected area is irradiated with visible red light, substantially within the range of 610-680 nm, and preferably having a maximum intensity around 630 nm. The intensity of the light may be in the range 0.1-1000 mW/cm², and preferably within the range 1-100 mW/cm². The total light dose may be within the range 0.1-200 J/cm², and preferably within the range 0.5-100 J/cm². The light may be pulsed or continuous.

For visible red light, the main photoacceptors are found inside the mitochondria, i.e. that part of the mitochondrial respiratory system that controls the energy level or metabolism of the cell and known as the redox chain. When visible light photons are absorbed by the redox chain, they transfer their energy to the respiratory system. When enough photons are absorbed, a photomodulated cascade of events is triggered within the cell, and the energy level of the entire cell is dramatically increased. This in turn changes the outer membrane permeability, and the now-excited cell exchanges energy-charged particles from its cytoplasm, especially calcium ions (Ca²⁺) and protons (H⁺) with other nearby cells via the extracellular environment. Thus, even unirradiated cells are excited by the messages they get from irradiated cells. The target cells are thus photoactivated, and either cell replication occurs faster, or the cells are stimulated into doing their job better. For example, photomodulated fibroblasts will produce more and better collagen fibres. Visible red light can thus be said to work from the inside of cells to the outside.

This embodiment may provide a method of cosmetic treatment. This method is suitable for photorejuvenation of aged or light-damaged skin, either with or without internally or externally applied photosensitizer. The method may be used for the reduction or removal of wrinkles.

Treatment with Near Infrared Light

In the second embodiment, the affected area is irradiated with near-infrared light, preferably with light of a wavelength substantially within the range of 800-880 nm, and preferably having a maximum intensity around 830 nm. The intensity of the light may be in the range 0.1-1000 mW/cm², and preferably within the range 1-100 mW/cm². The total light dose may be within the range 0.1-200 J/cm², and preferably within the range 0.5-100 J/cm². The light may be pulsed or continuous.

For near infrared light (800 nm-880 mm) the main photoacceptors are found firstly in the outer membrane of the cell, and secondly on the membranes of the subcellular organelles. When enough energy has been absorbed, the cell membrane permeability changes, more calcium ions and protons are produced in the cytoplasm, and more photons can penetrate into the cell, raising the energy level of the mitochondria through acting directly on their membranes. The same photo cascade of events is thus set in motion as in the case of the red visible light photons, but from a different stage. Thus the same end point is reached with IR photomodulation, namely cell proliferation, or the action potential of the cell is modulated. IR light can thus be said to work from the outside of the cell to the inside, and then back out again.

The fact that cells have specific photoacceptors thus explains why red light is best for modulating fibroblast function, whereas IR light is best for leukocytes and macrophages in inflammation control, and neurons (nerve cells) in pain control. However, IR light will still have some photocybomodulatory effect on fibroblasts, and red light will still have some photocybomodulatory effect on inflammatory and nerve cells, particularly those located more superficially, as IR photons can penetrate much more deeply than visible red photons.

This embodiment may provide a method of cosmetic treatment. This method is suitable for photorejuvenation of aged or light-damaged skin, either with or without internally or externally applied photosensitizer. The method may be used for the reduction or removal of wrinkles.

Pain Control

Light has a highly beneficial effect on nerve cells which blocks pain transmitted by these cells to the brain. Studies have shown that laser light increases the activity of the ATP-dependent NaK pump. In this case, laser light increases the potential difference across the cell membrane moving the resting potential further from the firing threshold, thus, decreasing nerve ending sensitivity. A less understood pain blocking mechanism involves the product of high levels of painkilling chemicals such as endorphins and enkephalins from the brain, adrenal gland and other areas, as a result of stimulation by light.

Also in pain therapy, to get photons deep into the major joints such as the shoulder, elbow, hip, knee and ankle joints, then the better penetration of infrared light allows a deeper delivery of photons to the target cell.

The second embodiment may therefore be used for the reduction or control of pain, for example during photodynamic treatment of psoriasis, for analgesic effect during other clinical applications, or as a result of injury.

Wound Healing

The wavelengths and intensities of the first and second embodiments may also be used for wound healing.

Good and predictable wound healing is most important. Occasionally, however, a wound does not heal as well as it should, and this can cause problems such as hypertrophic or atrophic scarring or chronic ulceration. For the plastic surgeon, these are unacceptable outcomes. There are three phases of wound healing, namely the inflammatory, proliferative and remodelling phases. Wound healing-associated cells are the primary target for light therapy. There are distinct cell cycles associated with wound healing. In the inflammatory phase, mast cells and polymorphonuclear leukocytes peak earliest, and fall off almost completely by the end of the inflammatory stage. Monocytes, transforming to macrophage cells, appear also during the first phase, and remain in quantity as differentiated macrophage cells until well into the second phase. Some macrophage cells will still be found during the remodelling phase. Fibroblasts, already present in the wound or differentiated from pericytes attracted to the wound, begin to appear from about day 2 of the process, and peak during the proliferative phase. Many will exhibit myofibroblast transformation towards the end of this phase, and most will gradually transform to inactive fibrocytes after 80 to 100 days into the wound healing process. Research has shown us that specific wavelengths of incident light energy have particular cellular targets. The wavelength specificity of cellular targets has been greatly elucidated at an in vitro level. In vitro data [Abergel], [Karu], [Smith] and [Young] show visible red light energy to have the greatest effect on raising the action potential of fibroblasts, but also has a marked effect on mast cell degranulation, multinuclear leukocytes and less so on mononuclear macrophage cells. They also show 830 nm is extremely efficient in accelerating the degranulation of mast cells, and significantly raises the action potential of both leukocytes and macrophage cells. However, 830 nm is less effective in raising the action potential of fibroblasts, but accelerates the fibroblast to myofibroblast transformation.

Wound healing is a complex biochemical process that commences immediately after tissue injury. A coagulation phase is characterized by low oxygen tension and the formation of platelet plugs. Macrophages, polymorphnuclear neutrophils and lymphocytes appear during the inflammatory phase for debris and infection control, and growth factors are secreted for fibroplasias, angiogenesis and re-epithelialisation.

The first and second embodiments described above may be used for healing damaged tissue, sports-related injuries, or skin ulcers.

Photorejuvenation with 585 nm

In the third embodiment, the affected area is irradiated with yellow light, preferably with light of a wavelength substantially within the range of 560-610 nm, and preferably having a maximum intensity around 585 nm+/−10 nm. The intensity of the light may be in the range 0.01-100 mW/cm², and preferably within the range 0.1-30 mW/cm². The total light dose may be within the range 0.01-200 J/cm², and preferably within the range 0.1-30 J/cm². The light may be pulsed or continuous.

For yellow light (560 nm-610 nm) the main photoacceptors are found in the main absorption bands of haemoglobin. When enough photons are absorbed, a photomodulated cascade of events is triggered within the cell, and the energy level of the entire cell is dramatically increased. The now-excited cell exchanges energy-charged particles from its cytoplasm, especially calcium ions (Ca²⁺) and protons (H⁺) with other nearby cells via the extracellular environment. Thus, even unirradiated cells are excited by the messages they get from irradiated cells. The target cells are thus photoactivated, and either cell replication occurs faster, or the cells are stimulated into doing their job better. Similar to visible red light, yellow light can thus be said to work from the inside of cells to the outside.

This embodiment may provide a method of cosmetic treatment. This method is suitable for photorejuvenation of aged or light-damaged skin, either with or without internally or externally applied photosensitizer. The method may be used for the reduction or removal or wrinkles.

Polychromatic Light

A fourth embodiment of the invention is directed to healing wounds or damaged tissue using non-coherent polychromatic visible and infrared light, for example within the wavelength range 405 nm-904 nm, which penetrates the skin and is absorbed by photoreceptors in the cell membrane and mitochondria. The photons create a biochemical response, stimulating singlet oxygen, cellular cytochromes and transient free radical production which results in the formation of proton gradients that facilitates physiological changes resulting in the cessation of pain and a reduction in inflammation and improvement in wound and tissue repair.

[Agaiby] has shown the responsiveness of the cellular components of wound healing to photon stimulation. The increase in cellular energy and tissue oxygenation, enhanced microcirculation and synthesis of specialized signalling proteins, such as growth factors, have been shown to be influenced by photons and can lead to the acceleration of wound healing.

Enhanced microcirculation results in an increase in new capillaries as well as new blood vessels, to replace damaged ones. This leads to an increase in the healing process because the vessels can deliver more oxygen and nutrients necessary for healing in addition to an increased removal of waste products. Stimulation of collagen increases the body's capacity to repair damaged tissue and to replace old tissue. Stimulation of adenosine triphosphate (ATP) boosts the transport of energy to all cells. An increase in ATP increases nutrient absorption and waste disposal by cells. An increase in the lymphatic system activity can be brought about by an increase in the lymph vessel diameter and lymph flow rate. Hence, the inventor has realized that modulation of wound healing and/or tissue repair can be achieved by irradiation of the wound or damaged tissue simultaneously by infrared and visible light. Venous and arterial diameters could also be increased in a similar manner.

The absorption of infrared light by photoreceptors within the tissue leads to signal transduction and amplification, and finally results in the photoresponse. Infra red and long-wavelength visible light are absorbed by components of the respiratory chain (i.e. flavine dehydrogenases, cytochromes and cytochrome oxidase), which cause an activation of the respiratory chain and the oxidation of NAS pool which leads to changes in the redox status of both the mitochondria and the cytoplasm. This in turn has an effect on membrane permeability/transport, with changes in the Na′/H′ ratio and increases in Na′/K′-ATPase activity, which in turn has an effect on the Ca++ flux. The Ca++ flux affects the levels of cyclic nucleotides, which modulates DNA and RNA synthesis, which modulates cell proliferation (i.e. biostimulation). Infra-red light initiates the response at the membrane level probably through photophysical effects on Ca++ channels) at about halfway through the total cascade of molecular events that lead to biostimulation, whereas long-wavelength visible light initiates probably by photoactivating enzymes in the mitochondria, a cascade of molecular events leading to the photoresponse.

The photobiochemical processes involved in wound healing and tissue repair are governed by action spectra. [Beauvoit] demonstrates that mitochondria provide 50% of the tissue absorption coefficient and 100% of the light scattering at 780 nm due to cytochrome aa3, cytochrome oxidase and other mitochondria chromophores. [Karu 89] demonstrates a peak in increased RNA/DNA synthesis by radiation at wavelengths of 633, 680 and 780 nm, increased protein synthesis at 750 nm and increased cell proliferation at 890 nm.

Infrared light can penetrate to a depth of several centimetres, which it makes it more effective for full-thickness treatment of bones, joints, muscle, etc. Macrophages can inhibit or enhance the activity of many kinds of cells. Light of different wavelengths affects the ability of macrophages to release factors that cause the above effects. Therefore, infra red light therapy has great potential as a modulator of wound repair.

In one embodiment, wounds that are prone to hypertrophy or to keloid formation are treated with wavelengths stimulating the release of inhibiting factors (e.g., prostaglandins) that suppress fibroblast activity. In vitro studies show that 880 nm light had an inhibitory effect on fibroblast proliferation.

In another embodiment, applicable to cases such as varicose ulcers, for example, where the problem is one of delayed repair, wavelengths enhancing the release of stimulating factors (e.g. monoldnes) are applied to encourage activity and the development of granulation tissue. In vitro studies show that 820 nm and 870 nm light was stimulatory.

The fourth embodiment may also be applied to a method of cosmetic treatment of the skin.

Treatment of Hypopigmentary Skin Disorders

A fifth embodiment of the present invention is directed to a method of treatment of hypopigmentary skin disorders using ultraviolet (UV) or near-UV light.

Low intensity UV irradiation can stimulate melanocytic migration and proliferation, and mitogen release for melanocyte growth, thereby providing a microenvironment for inducing repigmentation in hypopigmentary conditions such as vitiligo [Tjioe]. There are very sensitive (near) ultra-violet peaks in the RNA/DNA synthesis/stimulation action spectra at 365, 404 and 434 nm [Karu 89], which would result in doses at least an order of magnitude lower than those required at 450, 560 and 633 nm (i.e. 5-50 J/m² compared with 500-5,000 J/m²). There are further peaks around 760 nm which correspond to increased stimulation of ATP.

In a method of treatment in the fifth embodiment, an external affected area (e.g. a wound or damaged tissue) of a patient to be treated is exposed to one or more suitable wavelengths at an intensity which is preferably between 1 and 50 mW/cm², but may be between 0.1 and 500 mW/cm². Suitable treatment doses range from 0.5 to 20 J/cm², but could range from 0.1 to 200 J/cm². Treatment times preferably range from 2 to 10 minutes, but may range from 0.5 to 30 minutes. A therapeutic course may consist of up to 30 treatments with intervals between 0.5 to 7 days.

In a method of treatment in the fifth embodiment, a pseudocatalase (e.g. Vitises™ from SES Derma, Valencia, Spain) may be applied twice daily to boost the low catalase activity often found in hypopigmented patients. Excess pseudocatalase is removed just before light application. A hypopigmented area of the skin of the patient is exposed to one or more suitable wavelengths at an intensity which is preferably between 0.1 and 50 mW/cm², but may be between 0.05 and 100 mW/cm². Suitable treatment doses range from 0.01 to 100 J/cm², but may range from 0.05 to 100 J/cm². Treatment times preferably range from 0.5 to 10 minutes, but may range from 0.1 to 30 minutes. A therapeutic course consists of up to 100 treatments with intervals ranging from 1 to 7 days.

Apparatus

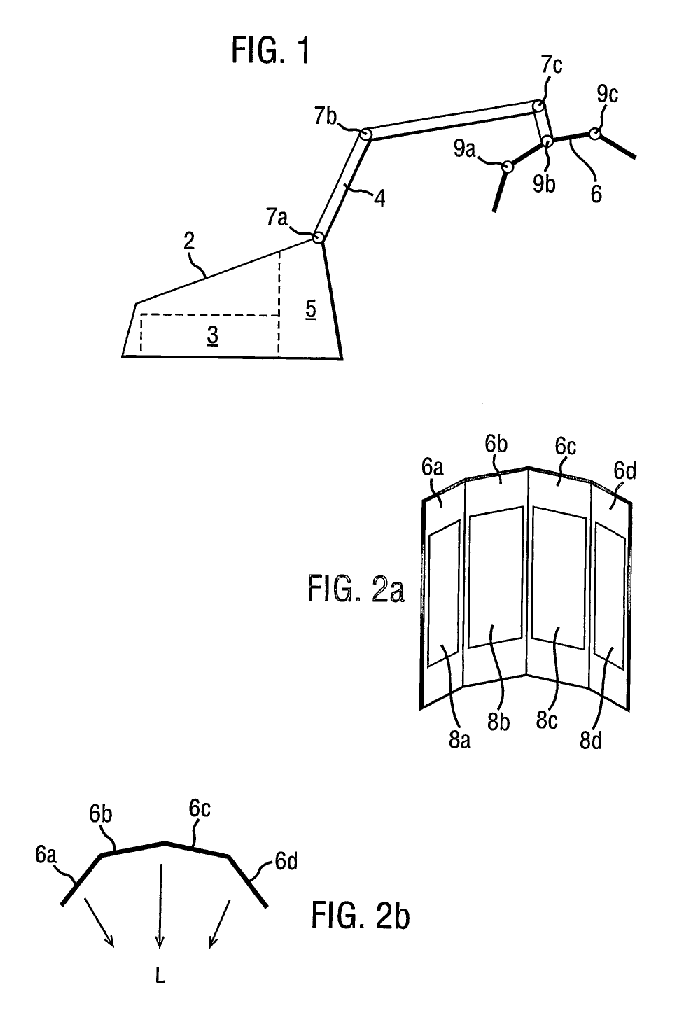

Apparatus suitable for use in the above embodiments is illustrated in FIGS. 1 to 4. A therapeutic light source comprises a base 2, an articulated arm 4 and a light-emitting head 6. The base 2 contains a power supply 3 for supplying electrical power to the light-emitting head 6, and a controller 5 for controlling the supply of power to the head 6. The controller 5 includes a switch and a timer for controlling the switch to determine the interval for which the head is switched on and emits light. The head may be switched on continuously over the interval, or may be pulsed on and off with a periodicity and duty cycle controlled by the controller 5. The interval, periodicity and duty cycle may be programmed into the controller 5 by a user by means of a keypad and display screen (not shown).

The articulated arm 4 is connected to the base 2 by a hinged joint 7a and is articulated along its length by further hinged joints 7b and 7c to give a sufficient degree of freedom in the position and angle of the head 6. The arm 4 carries a power connector from the controller 5 to the head 6.

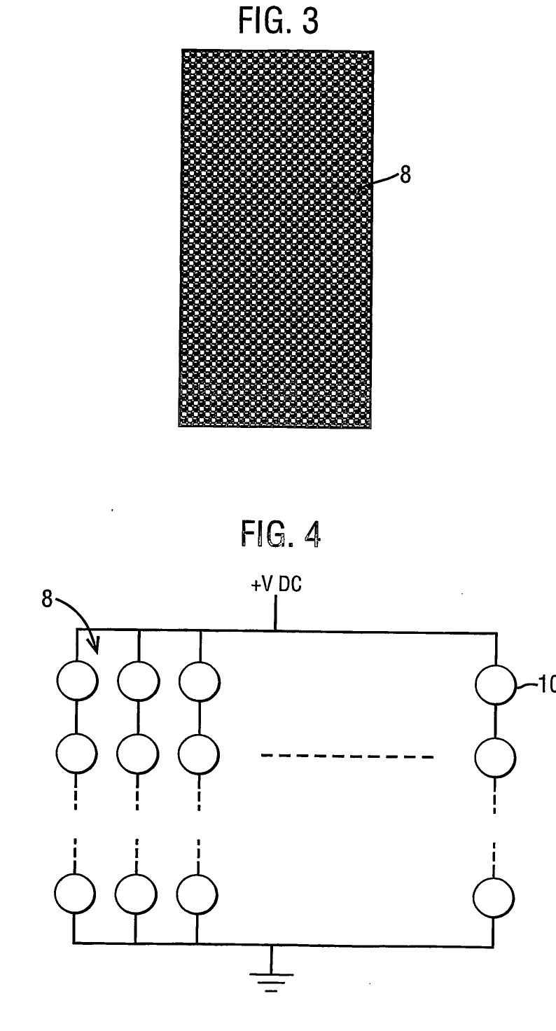

The head 6, as shown more particularly by FIG. 2a, consists of four rectangular panels 6a, 6b, 6c, 6d arranged side by side and joined at their edges by hinges 9a, 9b, 9c. Each panel 6 carries on its front face a corresponding matrix 8a, 8b, 8c, 8d of discrete light-emitting diodes (LED's).

As shown in FIG. 2b, the panels 6a-6d can be angled to form a concave surface such that light L emitted by the LED's is concentrated on an area of the patient to be treated.

FIG. 3 shows the physical arrangement of LED's in the matrix 8, while FIG. 4 shows the series-parallel electrical connection between the LED's 10. A direct current (DC) voltage +V is applied across the matrix when power is supplied to head 6.

In the first embodiment, the LEDs 10 emit in a narrow spectrum, within the range 610 to 680 nm, and preferably substantially at 630 nm. For example, the peak emission may be between 625 and 635 nm.

In the second embodiment, the LEDs 10 emit in a narrow spectrum, within the range 800 to 880 nm, and preferably substantially at 830 n. For example, the peak emission may be between 810 and 850 nm.

In the third embodiment, the LED's 10 emit in a narrow spectrum, within the range 550 to 600 nm, and preferably substantially at 585 nm. For example, the peak emission may be between 575 and 595 nm.

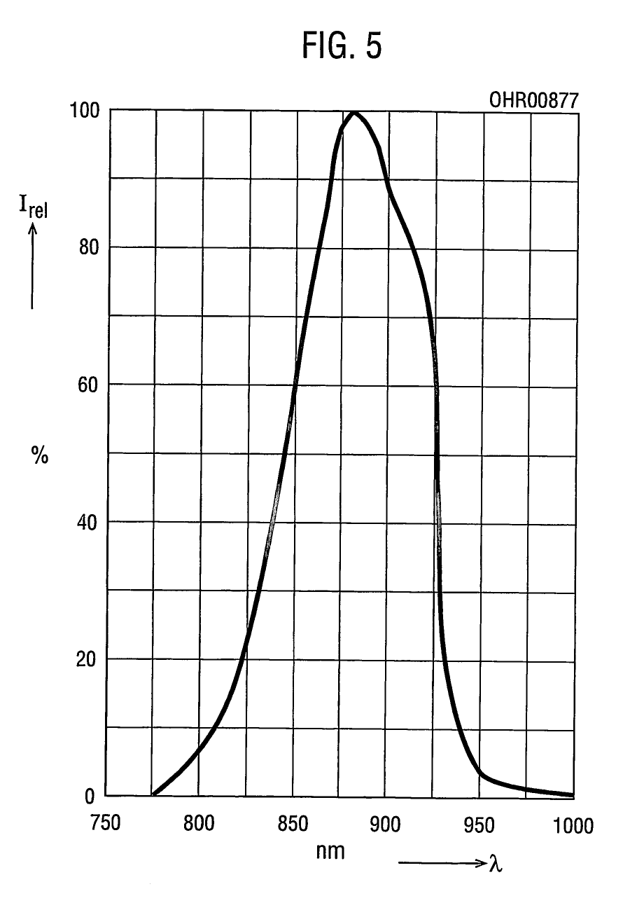

In the fourth embodiment, the LEDs 10 emit in the red and near infra-red spectrum, for example substantially in the range 660-950 nm. The LEDs may have GaAlAs substrate material. One suitable type of LED is Osram™ part no. SFH 4289, for which the emission spectrum is shown in FIG. 5. The spectrum has a peak at 880 nm. The LEDs 10 may be of two or more different types, at least one of which emits in the infrared and one of which emits in the red area of the spectrum. Both types may be switched on together.

Preferably, the combined emission spectra of the LEDs 10 have substantial intensity at one, or preferably more than one, of the wavelengths mentioned above with reference to the first to fourth embodiments.

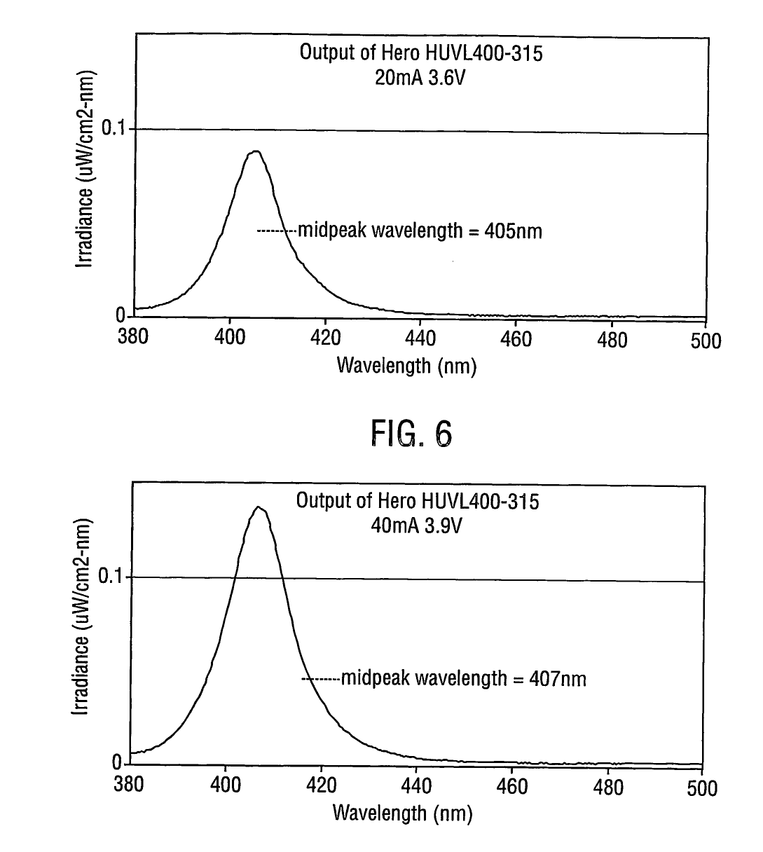

In a fifth embodiment, the LEDs 10 are ultraviolet (UV) emitting LEDs having emission spectra substantially in the near UV spectrum. The LEDs may have InGaN or GaN or InGaN/SiC substrate materials. One suitable type of LED is Hero™ part no. HUVLA00-315, having a peak at 400-410 nm, and emission spectra as shown in FIG. 6.

The LEDs 10 may be of two or more different types, both of which may be switched on together.

Preferably, the combined emission spectra of the LED's 10 have substantial intensity at one, or preferably more than one, of the wavelengths mentioned above with reference to the second embodiment.

The above embodiments are provided purely by way of example. Other variants will be apparent from the above description but may nevertheless fall within the scope of the following claims.

### REFERENCES

1. Agaiby et. al, ‘Laser modulation of T-lymphocyte proliferation in vitro’, Laser Therapy, 1998, 10, 153-158
2. Abergel R P et al: Biostimulation of wound healing by lasers. J Dermatol Surg Oncol, 13, 1987, 127-133.
3. Beauvoit B et. al., ‘Analytical Biochemistry’ 1995, 226, 1670-174
4. Karu T I: Low power laser therapy. Biomedical Photonics Handbook, Ch 48. CRC Press 2003.
5. Karu T I: Primary and secondary mechanisms of action of visible to near-IR radiation on cells. J Photochem Photobiol B Biol, 49, 1999, 1-17.
6. Karu T, ‘Health Physics’, 1989, 56, 691-704
7. Smith K C: The photobiological basis of low level laser radiation therapy. Laser Therapy 3, 1991, 19-25.
8. Tjioe M et al. ‘Acta Derm Venereol’ 2002, 82(5), 369-372
9. Young S et al. Macrophage responsiveness to light therapy. Lasers in Surg and Med, 9, 1989,497-505.

1. A method of cosmetic treatment of a patient, comprising irradiating an affected area with narrow bandwidth non-laser light having a predominant wavelength within the range 610-680 nm.

2. A method according to claim 1, wherein the predominant wavelength is within the range 625 to 635 nm.

3. The method of claim 2, wherein the predominant wavelength is substantially 630 nm.

4. A method of cosmetic treatment of a patient, comprising irradiating an affected area with narrow bandwidth non-laser light having a predominant wavelength within the range 800-880 nm.

5. The method of claim 4, wherein the predominant wavelength is within the range 810 and 850 nm.

6. The method of claim 5, wherein the predominant wavelength is substantially 830 nm.

7. The method of any preceding claim, wherein the intensity of the light is in the range 0.1-1000 mW/cm².

8. The method of claim 7, wherein the intensity of the light is in the range 1-100 mW/cm².

9. The method of claim 1 or claim 4, wherein the total light dose of the treatment or a treatment session is in the range 0.1-200 J/cm².

10. The method of claim 9, wherein the total light dose is in the range 0.5-100 J/cm².

11. The method of claim 1 or claim 4, wherein the cosmetic treatment comprises photorejuvenation.

12. The method of claim 11, wherein the treatment includes the application of a photosensitizer to the affected area before the step of irradiating.

13. The method of claim 12, wherein the photosensitizer is endogenously applied.

14. The method of claim 12, wherein the photosensitizer is exogenously applied.

15. The method of claim 11, wherein the treatment does not include the application of a photosensitizer to the affected area before the step of irradiating.

16. The method of claims 1 or claim 4, wherein the cosmetic treatment comprises the reduction or removal of wrinkles.

17. A method of healing wounds or skin ulcers, comprising irradiating an affected area with narrow bandwidth non-laser light having a predominant wavelength within the range 610-680 nm.

18. The method of claim 17, wherein the predominant wavelength is within the range 625 to 635 nm.

19. The method of claim 17, wherein the predominant wavelength is substantially 630 nm.

20. A method of healing wounds or skin ulcers, comprising irradiating an affected area with narrow bandwidth non-laser light having a predominant wavelength within the range 800-880 nm.

21. The method of claim 20, wherein the predominant wavelength is within the range 810 to 850 nm.

22. The method of claim 20, wherein the predominant wavelength is substantially 830 nm.

23. The method of any one of claims 17 to 22, wherein the intensity of the light is in the range 0.1-1000 mW/cm².

24. The method of claim 23, wherein the intensity of the light is in the range 1-100 mW/cm².

25. The method of claims 17 or claim 20, wherein the total light dose of the treatment or a treatment session is in the range 0.1-200 J/cm².

26. The method of claim 25, wherein the total light dose is in the range 0.5-100 J/cm².

27. A method of pain reduction, comprising irradiating an affected area with narrow bandwidth non-laser light having a predominant wavelength within the range 800-880 nm.

28. The method of claim 27, wherein the predominant wavelength is within the range 810 to 850 nm.

29. The method of claim 28, wherein the predominant wavelength is substantially 830 nm.

30. The method of any one of claims 27 to 29, wherein the intensity of the light is in the range 0.1-1000 mW/cm².

31. The method of claim 30, wherein the intensity of the light is in the range 1-100 mW/cm².

32. The method of claim 27, wherein the total light dose of the treatment or a treatment session is in the range 0.1-200 J/cm².

33. The method of claim 32, wherein the total light dose is in the range 0.5-100 J/cm².

34. A method of photorejuvenation of the skin, comprising irradiating the area to be treated with narrow bandwidth non-laser light having a predominant wavelength in the range 560-610 nm.

35. The method of claim 34, wherein the predominant wavelength is within the range 575 to 595 nm.

36. The method of claim 35, wherein the predominant wavelength is substantially 585 nm.

37. The method of any one of claims 34 to 36, wherein the intensity of the light is in the range 0.01-100 mW/cm².

38. The method of claim 37, wherein the intensity is within the range 0.1-30 mW/cm².

39. The method of claim 34, wherein the total light dose is within the range 0.01-200 j/cm².

40. The method of claim 39, wherein the total light dose is within the range 0.1-30 J/cm².

41. The method of any one of claims 1, 17, 20, 27, or 34, wherein the light is emitted by one or more light-emitting diodes.

42. The method of any one of claims 1, 17, 20, 27, or 34, wherein the light is pulsed.

43. The method of any one of claims 1, 17, 20, 27, or 34, wherein the light is substantially continuous.

44. The method of any one of claims 1, 17, 20, 27, or 34, for treatment of a mammal.

45. The method of claim 44, wherein the mammal is a human.

46. The method of claim 44, wherein the mammal is non-human.

47. A therapeutic light source arranged to emit polychromatic light substantially within the wavelength range of 405 to 904 nm.

48. The light source of claim 47, wherein the radiation has substantial intensity at a wavelength of one or more of 633, 680 or 780 nm.

49. The light source of claim 47 or claim 48, wherein the radiation has substantial intensity at a wavelength of 750 nm and/or 890 nm.

50. The light source of claim 47, wherein the radiation has substantial intensity at a wavelength of 880 nm.

51. The light source of claim 47, wherein the radiation has substantial intensity at a wavelength of 820 and/or 870 nm.

52. The light source of claim 47, including an array of discrete light-emitting diodes arranged to emit the polychromatic light.

53. The light source of claim 47, including a plurality of arrays of light-emitting diodes each arranged to emit the polychromatic light, the configuration of the plurality of arrays being adjustable by the user.

54. The light source of claim 53, wherein the plurality of arrays are mounted on an adjustable arm.

55. A method of modulating healing of wounds and/or damaged tissue, comprising irradiating affected tissue with incoherent radiation simultaneously including infrared light and visible light.

56. The method of claim 55, wherein the radiation comprises polychromatic light substantially within the wavelength range of 405 to 904 nm.

57. The method of claim 56, wherein the radiation has substantial intensity at a wavelength of one or more of 633, 680 or 780 nm.

58. The method of claim 56 or claim 57, wherein the radiation has substantial intensity at a wavelength of 750 nm and/or 890 nm.

59. The method of claim 56, wherein the radiation has substantial intensity at a wavelength of 880 nm.

60. The method of claim 59, wherein the wound is of a type prone to hypertrophy or keloid formation.

61. The method of claim 56, wherein the radiation has substantial intensity at a wavelength of 820 and/or 870 nm.

62. The method of claim 61, wherein the damaged tissue arises from delayed repair.

63. The method of claim 62, wherein the tissue is a varicose ulcer.

64. The method of claim 55, wherein the radiation has a total intensity of between 0.1 and 500 mWcm⁻².

65. The method of claim 64, wherein the radiation has a total intensity of between 1 and 50 mWcm⁻².

66. The method of claim 55, wherein the total radiation dose per treatment is between 0.1 and 200 Jcm⁻².

67. The method of claim 66, wherein the total radiation dose per treatment is between 0.5 and 20 Jcm⁻².

68. The method of any one of claims 55 to 67, wherein the total time per treatment is between 0.5 and 20 minutes.

69. The method of claim 68, wherein the total time per treatment is between 2 and 10 minutes.

70. The method of any one of claims 1, 17, 20, 27, 34, 47, or 55, wherein the radiation is emitted by an array of light-emitting diodes.

71. A method of treatment of a hypopigmentary skin disorder, comprising irradiating a hypopigmented area of a patient's skin with radiation including low intensity ultraviolet radiation.

72. The method of claim 71, wherein the low intensity ultraviolet radiation has substantial intensity at a wavelength of at least one of 365, 400-420 and 434 nm.

73. The method of claim 71 or claim 72, wherein the radiation also has a substantial intensity at a wavelength of approximately 630 nm or 760 nm.

74. A method of treatment of a hypopigmentary skin disorder, comprising irradiating a hypopigmented area of a patient's skin with low intensity red light.

75. The method of claim 74, wherein the light has a substantial intensity at a wavelength of approximately 630 nm or 760 nm.

76. The method of claim 71 or claim 74, wherein the total intensity of the radiation is between 0.05 and 100 mW/cm².

77. The method of claim 76, wherein the total intensity of the radiation is between 0.1 and 50 mW/cm².

78. The method of claims 71 or claim 74, wherein the radiation dose per treatment is between 0.01 and 100 J/cm².

79. The method of claim 78, wherein The radiation dose per treatment is between 0.05 and 100 J/cm².

80. The method according to claim 71 or claim 74, including applying a pseudocatalase to the hypopigmented area before the step of irradiation.

81. The method of claim 71 or claim 74, wherein the skin disorder is vitiligo.

82. A method of modulating healing of wounds and/or damaged tissue, comprising irradiating affected tissue with incoherent infrared radiation having substantial spectral intensity at at least one of 820 nm, 870 nm, 880 nm and 890 nm wavelength.

83. The method of claim 14, wherein the light is emitted by one or more light-emitting diodes.

84. The method of claim 14, wherein the light is pulsed.

85. The method of claim 14, wherein the light is substantially continuous.

86. The method of claim 14, for treatment of a mammal.

87. The method of claim 14, wherein the radiation is emitted by an array of light-emitting diodes.
